(19) United States
(12) Patent Application Publication
(10) Pub. No.: US 2007/0186653 A1
(43) Pub. Date: Aug. 16, 2007

(54) Speed measurement

(76) Inventor: Klaus Wolter, Dusseldorf (DE)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/566,075

(22) PCT Filed: Jul. 23, 2004
(86) PCT No.: PCT/EP04/08258

§ 371 Date: Jan. 3, 2007

(30) Foreign Application Priority Data
Jul. 25, 2003 (DE) 103 34 275.3
Jan. 14, 2004 (DE) 10 2004 002 123.6
Jan. 21, 2004 (DE) 10 2004 003 259.9
Jun. 24, 2004 (DE) 10 2004 030 668.0

(51) Int. Cl. G01P 3/36

(52) U.S. Cl. 73/504.01; 73/510

(57) ABSTRACT

The invention relates to a speed measuring device. The aim of the invention is to allow a precise and flexible speed measurement. The aim is achieved, whereby emission components are transmitted through two different paths and detected. A modification to the phase shift between the emission components in both paths, in relation to a non-operating device, represents a rate for the actual speed of the device, for evaluation means. The influence of a rotary motion on a modification to the phase shift is thus prevented or compensated. The invention also relates to a system, provided with such a device, and to a corresponding method of speed measurement.

The invention relates to a device, a system, and a method for the measurement of a speed.

At present there are very widely differing methods and devices used for the measuring of speeds of a device or a system. As a rule, however, these are not particularly accurate, require a large amount of space, or require external information.

In the chapter “Navigation, Sagnac Effect and Michelson Experiment” by M. Böhm, from the book “Ortung und Navigation” (Location and Navigation), 1984, hypothetical considerations are given to an absolute speed measurement. It is assumed that a LASER sends a signal over two parallel adjacent propagation paths of the same length with different refractive indices. The inertial translatory speed can be measured directly by means of the time difference. As an alternative, a corresponding evaluation of sound signals is also mentioned. As the result, this text apostrophises impossibility.

The invention is now based on the object of providing a really attainable, independent, and reliable speed measurement.

This object is resolved by a device for the measurement of a speed. The device comprises at least one source, designed to generate at least one emission. The device further comprises at least two paths, on which at least a part of the at least one emission generated by the at least one source propagates with a respective known wavelength and a respective known propagation speed. In this situation, the paths are formed in such a way that a translatory movement of the device causes a phase displacement between the emission parts propagated on the at least two paths. The device further comprises evaluation means designed for the detection of emission parts which leave the at least two paths, and for the determination of the speed of the device in at least one spatial direction by the evaluation of a change in the phase displacement between the detected emission parts in comparison with a phase displacement with the device at rest. Finally, the device is designed in such a way that a change in the phase displacement of the emission parts detected by the evaluation means due to a rotational movement of the device is prevented or compensated for.

The term “wavelength” is used here to designate the universal physical wavelength which is assignable to every object.

The object of the invention is likewise resolved by a system which comprises one or more such devices for the detection of the speed of the system.

Finally, the object is also resolved by a method for the measurement of the speed of a device. The method comprises a generation of at least one emission. The method further comprises a transfer of at least a part of the at least one emission on at least two paths, respectively, with a respective known wavelength and a respective known propagation speed. In this situation, a translatory movement of the device causes a phase displacement between the emission parts propagating on the at least two paths. The method further comprises a detection of the emission parts leaving the at least two paths, and a determination of the speed of the device in at least one spatial direction by evaluation of a change in the phase displacement between the detected emission parts in comparison with a phase displacement with the device at rest. In this situation, a change in the phase displacement of the emission parts due to a rotational movement of the device is prevented or compensated for.

The invention is based on the one hand on the consideration that the Sagnac effect can be applied not only hypothetically to speed measurement. The invention is based on the other hand, however, on the consideration that in the hypothetical device from Böhm the measurement result may be falsified by rotational movements of the device.

It is therefore proposed that, for the speed measurement, on the one hand the change be detected in a phase displacement between emission parts propagating on two different paths, and that, on the other hand, an influence of a rotational movement be prevented. The measurement direction is determined in this situation from the degrees of freedom of the propagation of the emission parts fed into the paths. The invention has the advantage that it allows for a reliable and independent speed measurement. At the same time, it can be implemented in an extremely small space and can therefore be used particularly flexibly and versatilely.

Advantageous embodiments of the invention are derived from the sub-claims.

The at least one source can be formed in the most widely differing manner. It may comprise a light source, for example, such as in the form of any desired type of LASER. As an alternative, the source can also comprise, for example, a MASER or an electron beam source. The at least one source can further generate emissions at an emission location or at spatially separated emission locations. The emission parts fed to the at least two paths can further be emitted simultaneously or with a temporal interval. The only consideration is that the phase displacement resulting on the two paths between the emission parts in the state of rest of the device is known. It is understood that when the at least one source generates several emissions the individual emission part can also comprise a complete emission, respectively.

The paths used can likewise be formed in the most widely differing manner, provided that they are suitable for conducting onwards the emission parts created by the source. The paths can consist of the same material or of different materials. An individual path can also be homogenous or inhomogeneous. It can thus consist throughout of one material or be composed of several sections of different materials. If the source comprises a light source, the paths can comprise e.g. an optical fiber or reflectors, which determine the course of the individual path by deflections of the emission part.

A change in the phase displacement between the emission parts propagating on the at least two paths due to a translatory movement of the device can be attained in that the emission parts on the two paths in the state of rest of the device require different periods of time to run over the path, i.e. due to different physical lengths of the paths. This can be attained, for example, by the geometric track length on one path being longer than on the other, and/or due to the propagation speed on the one path being longer than on the other, due, for example, to different refraction indices of different materials used. The greater the run-time difference on the two paths, the greater the resolution of the speed acquired.

In addition, the influence of a rotational movement on the speed determination can be eliminated in different ways.

Thus, for example, the paths can already be designed in their geometric arrangement in such a way that a rotational influence on the phase angle of the emission parts is prevented from the outset. This can be achieved by the paths, outside an imaginary straight line, exhibiting path parts of the same size on opposing sides of this straight line. The imaginary straight line can in this situation, for example, connect a common starting point and a common end point of the paths. It corresponds as a rule to the direction of measurement of the device.

As an alternative, however, a subsequent calculated compensation can be effected for a rotational movement. For this purpose, the rotational movement of the device is detected separately. The determined change in phase displacement of the emission parts on the two paths is then corrected in accordance with the rotary influence before the speed is determined.

In an advantageous embodiment of the invention, the at least two paths are designed in such a way that they exhibit at least one common path part. The emission parts fed into the at least two paths then run through the common path part in opposite directions. As a result, for one of the paths the components can be minimized in number and/or size, such as for example the number of reflectors or the length of the optical fibers, etc. In addition, a common path part reduces differences in the temperature and in other path conditions on the at least two paths, which could exert undesirable influences on the phase displacement.

The common path part can, for example, be designed in such a way that it exhibits a first path part which is run through by one of the emission parts in a direction of measurement of the device, and a second path part which is run through by this emission part in a direction opposite to the direction of measurement, the two path parts exhibiting a different physical length with the device at rest. As a result, it is ensured that one of the paths always exhibits a greater physical length in the direction of measurement than another of the at least two paths.

In an advantageous embodiment of the invention, the device further comprises an acceleration sensor, with which, even without movement, a reference to the local gravity normal can be established. This means that an acceleration sensor can be used to determine the orientation of the device in an initial state, taking which as a starting point the speed of the device can be determined according to the invention. Such an acceleration sensor can also be realized, for example, by means of a spirit level.

For a speed measurement in one single spatial direction, only one device according to the invention is required. This device is then arranged in such a way that its direction of measurement concurs with the desired spatial direction. In addition to this, the device can also be rotated for as long as required in each case until a maximum change in the phase displacement between the emission parts is attained. The movement direction then corresponds to the measurement direction of the device in the position in which the maximum change is attained.

For a simpler and faster detection of a speed in several directions, however, it is also possible in a system according to the invention for several devices according to the invention to be used, which detect the speed simultaneously in different spatial directions. In this context, optionally a single source can be used simultaneously for generating the emission for several of the devices. For example, a light source can feed a light signal simultaneously into a plurality of suitably arranged optical fibers. For the complete detection of translatory and rotational movements of a system, the system comprises at least six of the devices according to the invention. By mathematical calculation, with a suitable arrangement of the measurement directions of the six devices, any desired movement can be acquired in terms of size.

The precision of the measurements depends in particular on the wavelength of the emissions and on the run-time differences on the at least two paths.

The possible repetition rate of the measurements is dependent in particular on the run time of the emission part on the path with the longer run-time and on the time required for the evaluation.

A device according to the invention can be used in order to determine its own speed. In this case, the device itself can exhibit further components and functions, in particular such for which the speed measurement is of interest. If the device is brought into a fixed relationship with another moved object, however, then, by means of a device according to the invention, the speed of any desired object can also be determined. The same applies accordingly to the system according to the invention.

The invention can be applied in the most widely differing sectors, for example for the determination of speed, location, and position in a navigation system or for detecting the movements of a computer mouse. It is understood that the functions of structural features in the presented embodiments of the device according to the invention can also be used accordingly as functional features in embodiment examples of the method according to the invention, and vice-versa.

Embodiments of the invention are explained in greater detail on the basis of embodiments, making reference to drawings. These show:

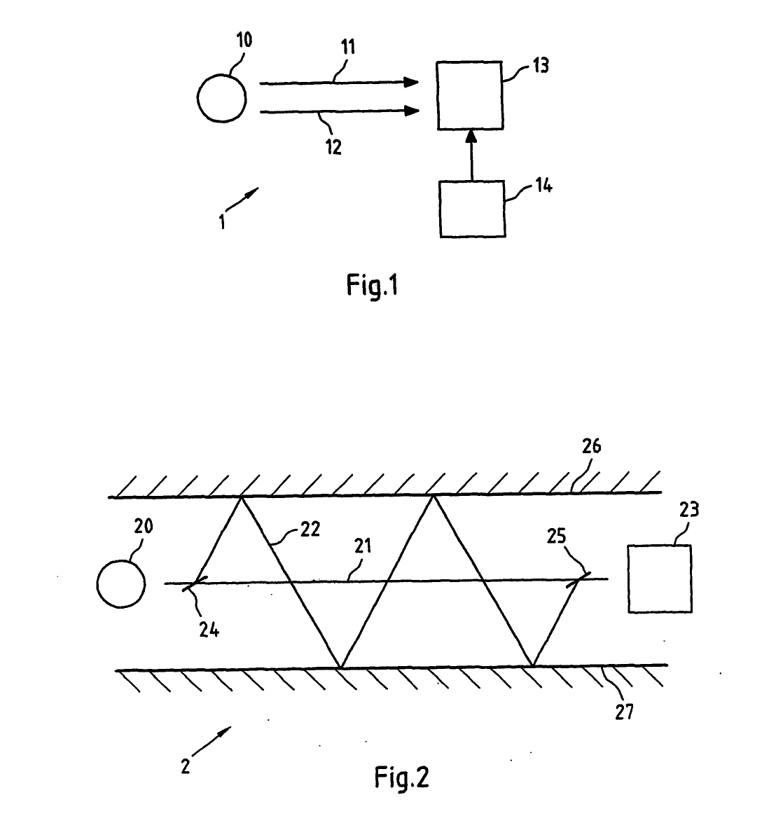

FIG. 1 Diagrammatic representation of a first embodiment of the device according to the invention,

FIG. 2 Diagrammatic representation of a second embodiment of the device according to the invention,

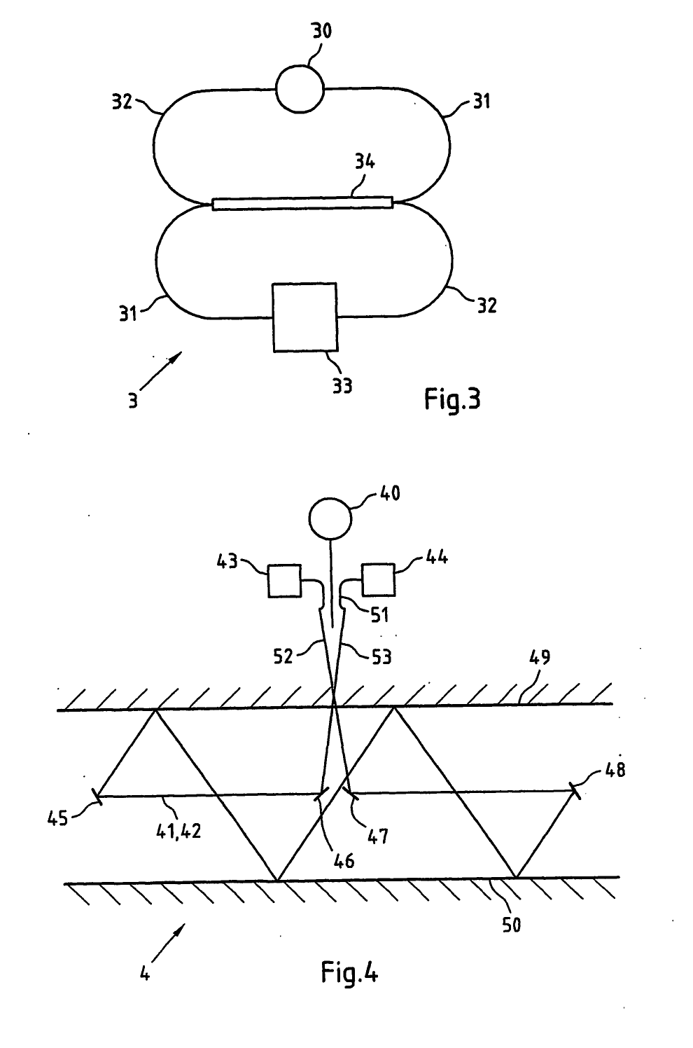

FIG. 3 Diagrammatic representation of a third embodiment of the device according to the invention,

FIG. 4 Diagrammatic representation of a fourth embodiment of the device according to the invention; and

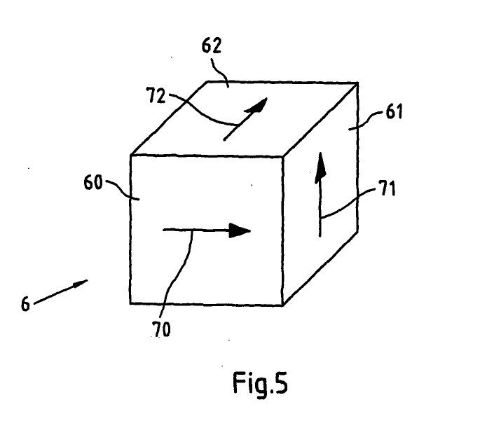

FIG. 5 Diagrammatic representation of the orientation of measurement arrangements for the measurement of any desired speeds with a device according to the invention.

FIG. 1 illustrates in diagrammatic form a first embodiment of the device according to the invention, which allows for a speed measurement in one direction.

In the device 1 a source 10 at an emission location is connected via two paths 11, 12 to a phase comparator 13 at a measuring location. In addition, a rotation measurement device 14 is connected to the phase comparator 13. The source 10 generates an emission at the time to from which parts with the same phase angle are fed into both paths 11, 12. The two paths 11 and 12 are arranged in such a way that the emission parts require different times to cover the route formed by the respective path.

The source 10 can, for example, be a LASER, which emits a light signal, and the two paths 11, 12 can, for example, be two optical fibers of equal length made of different materials with different refractive indices.

At the measurement location the emission parts of the two paths 11, 12 are superimposed to form an interference signal. The phase comparator 13 evaluates the interference signal. If the device 1 is in a state of rest, then, because of the different propagation speeds on the two paths 11, 12, a specific phase displacement occurs between the emission parts. On the path 11, for example, in the rest state, a run time of t₁can result, and on the path 12 a run time of t₂. The run time t₁is in this context a factor ‘a’ greater than t₂, i.e. t₁=a*t₂. As long as the device does not move, an interference signal is therefore formed at the measurement location from the emission parts generated at the times t₀ and t₀+(t₁-t₂).

If the device now moves with a direction component which corresponds to a connection line between the emission location and the measurement location then this phase displacement changes.

If the device 1 moves at a speed v=Δ1/Δt in the direction looking from the emission location towards the measurement location, then a phase displacement is added for both paths 11, 12 due to this movement. In this situation, Δ1 is the length of the paths 11, 12, and Δt the time which the device 1 requires for the distance Δ1. The run time increases due to the Sagnac effect on path 12 by Δt and on path 11 by a*Δt. At the exit of the path 11, therefore, a phase angle is present which corresponds to the phase angle of a path at rest with the run time of t₁+a*Δt, whilst at the exit of the path 12 a phase angle is present which corresponds to the phase angle of a path at rest with the run time of t₂+Δt. The change in the phase displacement between the emission parts on the two paths 11, 12 as a dependency of the speed v by (a−1) *Δt gives a periodic interference signal.

On the basis of the interference signal, the phase comparator 13 determines the amount of the change, and on the basis of this the translatory speed v of the device 1.

The speed which is determined can then be used in any manner desired, for example for a direct display of the speed on a display unit, or for calculations in a navigation system. The components required for the further processing of the speed determined can be integrated into the device 1 or connected to it externally, for example as part of another device.

If the two paths 11, 12 are arranged without any further considerations, such as parallel to each other as shown, a rotational movement of the device 1 also incurs a change in the phase displacement, though, which is superimposed on the described change in the phase displacement due to a translatory movement.

For this situation, the rotation measurement device 14 is provided, which detects a rotational movement of the device 1. The rotation measurement device 14 can be formed, for example, by means of a laser gyroscope. The rotation measurement device 14 delivers a signal to the phase comparator 13, which determines from it the proportion of the change in the phase displacement of the emission parts on both the paths 11, 12 due to a rotation of the device 1. Before the phase comparator 13 now determines the translatory speed of the device 1, based on the change in the phase displacement between the emission parts on the two paths 11, 12, it first subtracts from the change the part which results due to a rotational movement.

Such a separate rotation measurement device 14 is not required if the paths 11, 12 are already formed in such a way that any influence of a rotational movement on a change in the phase displacement between the emission parts on the paths 11 and 12 is prevented from the outset.

FIG. 2 shows in diagrammatic form a second embodiment of the device according to the invention, in which the paths are likewise formed so as to compensate for the influence of rotational movements.

The device 2 comprises again a source 20 at an emission location, as well as a phase comparator 23 with a detector, not represented separately, at a measurement location. Arranged on a direct connection line between the source 20 and the phase comparator 23 is a first beam divider 24 in the vicinity of the source 20 and a second beam divider 25 in the vicinity of the phase comparator 23. In addition, the section between the source 20 and the phase comparator 23 is delimited upwards and downwards by flat reflectors 26, 27.

If the source 20 generates an emission, then a first emission part propagates along the direct connection line to the phase comparator 23. To this end, the first beam divider 24 allows a first part of the emission to pass without deflection, and the second beam divider 25 allows the entire first emission part to pass.

On the other hand, a second part of an emission generated by the source 20 will be deflected upwards by the first beam divider 24. This second emission part impinges on the upper reflector 26, is reflected by this, impinges on the lower reflector 27, is reflected by this, and so on. The deflection angle through the first beam divider 24 is adjusted in this situation in such a way that the second emission part is, in the final situation, reflected from the lower reflector 27 precisely to the second beam divider 25. The second beam divider 25 in turn deflects the second emission part such that, just like the first emission part, it is conducted to the phase comparator 23.

Because of the different lengths of the paths 21, 22, the emission parts in this device 2 likewise require a different time to pass through the route formed by the respective path.

At the measurement location, the phase comparator 23 evaluates the interference signal resulting from the two emission parts. If the device is in a state of rest, then, because of the different route lengths, a specific phase displacement occurs between the emission parts. If the device moves with a direction component, which corresponds to the connection line between the emission location and the measuring location, then this phase displacement changes. The phase comparator 23 determines the amount of the change and, on the basis of this, the translatory speed of the device.

In this case, too, a separate compensation of phase changes due to possible rotational movements is not required, since such phase displacements are prevented by the symmetrical propagation of the emission parts between the source 20 and the phase comparator 23.

FIG. 3 shows in diagrammatic form a third embodiment of the device according to the invention, in which a part of the path is used twice over.

In this device 3, a source 30 is connected to a phase comparator 33 via a first path 31 and a second path 32. The middle part of the first path 31 and the middle path of the second path 32 is in this case realized via a common path section 34, which is arranged perpendicular to a connection line between the source 30 and the phase comparator 33, and is used in the opposite direction for the first path 31 and for the second path 32.

The source 30 creates an emission at two emission locations in phase with one another. One of the emissions is fed into the first path 31, and the other into the second path 32. At the end of the paths 31, 32, the emissions are detected by the phase comparator 33 and evaluated, as in the devices 1, 2, described with reference to FIGS. 1 and 2.

The two paths 31, 32, can in this situation be designed in such a way that changes in the phase displacement by a rotational movement of the device 3 are avoided. As an alternative, a subsequent compensation of such changes can be effected, as described with reference to FIG. 1.

FIG. 4 shows in diagrammatic form a fourth embodiment of the device according to the invention, in which a common path part is realized by folding.

The device 4 comprises a propagation medium which is delimited by two flat reflectors 49, 50. Arranged in the propagation medium, on a straight line parallel to the two reflectors 49, 50, are four reflectors 45, 46, 47, 48. This straight line also corresponds to the measurement axis of the device 4. The device 4 further comprises a light source 40 and two detectors 43, 44, above the propagation medium. The detectors 43, 44, are further connected to a phase comparator not represented.

A first part of an emission generated by the light source 40 is conducted by means of a splitter 51 via a left-hand optical fiber 52 onto the middle right-hand reflector 47, and a second part of this emission is conducted via a right-hand optical fiber 53 onto the middle left-hand reflector 46. The left-hand optical fiber 52 and the right-hand optical fiber 53 accordingly cross on the way from the splitter 51 to the respective reflector 47, 46.

The middle right-hand reflector 47 conducts an emission part coming from the splitter 51 on the straight line to the outer right-hand reflector 48. The outer right-hand reflector 48 deflects the emission part with opposed direction component to the lower reflector 50. From there the emission part is reflected to the upper reflector 49, onwards to the lower reflector 50, and again to the upper reflector 49. Finally, the emission part is conducted from the upper reflector 49 to the outer left-hand reflector 45. It is understood that the number of the reflections between the upper and lower reflectors 49, 50 can be as many as desired, as long as the same share occurs above and below the straight line.

The outer left-hand reflector 45 finally reflects the emission part to the middle left-hand reflector 46. The middle left-hand reflector 46 reflects the emission part into the right-hand optical fiber 53, via which the emission part leaves the propagation medium and is conducted to the right-hand detector 44.

By means of the reflectors 45 to 50, the emission part which is conducted from the splitter 51 to the right-hand optical fiber 53 takes the opposite route to the emission part conducted to the left-hand optical fiber 52. This emission part then leaves the propagation medium via the left-hand optical fiber 52, to be conducted to the left-hand detector 43.

The emission part fed into the right-hand optical fiber 53 accordingly propagates on a first path, and the emission part fed into the left-hand optical fiber 52 propagates on a second path opposed to this.

In this device 4 the length of the route is therefore the same for both paths, and the material used is also the same. In the state of rest, the detectors 43, 44 therefore do not detect any phase displacement between an emission part on the first path and an emission part on the second path.

However, if the device 4 is moved in a translatory movement with a direction component corresponding to the alignment of the straight line, then the emission part propagates on one of the paths for the most part in the direction of movement, and the emission part on the other of the paths propagates for the most part contrary to the direction of movement. The translatory movement accordingly has an opposed sign for the respective main direction of the two emission parts. From this there is derived a phase displacement between the two emission parts during a translatory movement.

The respective phase angle is detected by the detectors 43, 44, and forwarded to the phase comparator, which determines from this the present speed in the direction of the straight line.

The light source 40, the detectors 43, 44, and the splitter 51 of the device 4 can, for example, be taken over by a known fiber gyroscope.

It is understood that a speed which is determined in the devices 2, 3 and 4 can also be used in different manners, as mentioned with reference to the device 1.

FIG. 5 shows in diagrammatic form an embodiment of the system according to the invention, which allows for a measurement of any desired translatory and rotational speeds.

The system 6 is designed in the form of a cube. Each of the six faces of the cube comprises one of the devices according to FIGS. 1 to 4. On the three visible sides of the cube 60, 61, 62, the measurement axis 70, 71, 72 of the respective device is indicated. The three concealed faces of the cube comprise in each case a device with a measurement axis in an opposite alignment compared with the measurement axis 70, 71, 72 of the device on the opposite faces of the cube 60, 61, 62. A processing unit evaluates the speed of the system 6 detected for the six directions, and from this determines the entire speed of the system 6, including translatory and rotational speeds, and the direction or directions of movement.

The method and/or device presented here for the measurement of speed vectors (diagrammatic representation of the function by FIG. 1; Note: FIG. 1 does not represent any fixed specification for geometry) is based on the effects according to Fizeau, Sagnac, and Doppler and is characterized in that at least one (and/or several) emission location is present at one (and/or several) source, the emission of which is propagated on at least two paths at a respective known speed and at a respective known wavelength (here the universal physical wavelength is meant which is assignable to every object) and provides evaluable interferences in particular, but not necessarily only, for the time of the duration of a respectively required measurement at one or more measurement locations, as well as at least one of the paths from the emission location(s) of this type to the measurement location(s) of this type, in such a way that the phase angle provided on this path by a translatory event is displaced against that of a respective other path. In this situation, the paths are represented in such a way that a rotational event, a thermal influence, or other non-translatory influence, will not result in any displacement of the phase angles between these paths, or these superimposed events and influences are corrected by devices located outside the paths (=external devices). The displacement of the phase angles (=measurement signal) which produces the interference signal of these paths is then a measure for the speed. The direction is derived as the spatial direction for which the measurement signal for the given paths is at its maximum (=path of greatest difference). In particular, with the provision of a defined speed vector, this allows for the device-immanent measurement axis to be determined.

The paths described heretofore do not necessarily have to be homogenous; this means that they can also be composed in each case from several sections of different nature.

The effects referred to, and therefore the measurement signal, occur when the emission can propagate unimpeded on the planned propagation paths; in other words, the emission exhibits the required degrees of freedom for its propagation, and therefore the required degrees of freedom for the occurrence of the effects. Expressed by way of illustration and therefore simplified, if, for example, a photon in an optical wave guide is extant only in the longitudinal mode, then it has a degree of freedom only in this mode, and only in this degree of freedom will it have demonstrable effects. Accordingly, the selection of a preferred direction of measurement can and will be specified by the construction design and physical properties of the sensor, i.e. by the determination of the degrees of freedom of the propagation.

Expressed another way, the method and/or the device are characterized in that a source of whatever kind with emission locations for radiation is represented, which exhibits a known phase relationship between the emission locations of the measurement process-these emission locations can exhibit spatial and/or temporal interval spacing-and for which the paths (=routes) respectively exhibit a (greatest possible) displacement of the phase angles in relation to a translatory movement.

Determinant for the resolution of the method and/or device presented here, which is in principle possible, are the wavelength of the emission and the run-time difference on the paths. Subordinate to these are the capabilities of the phase comparator and the static and systematic errors.

There is a wide range of preferred forms of realization, of which only a few are considered in detail here, since they represent special cases of the principle within this wide range, and other embodiments are derivatives of these.

In one embodiment, the source is a light source. In general, a laser of any desired construction type (linear-ring laser (which can of course be further used for angle measurements), solid body, gas, or liquid lasers, to name only the generic terms. Techniques such as exotic physical effects, such as quantum well and super-fluorescence and the like plainly do not need to be enumerated individually). And accordingly, the speed of light is provided as a known speed.

In a further embodiment, the source is any type of maser whatsoever.

As solutions for the paths, in further embodiments mention may in particular be made on the one hand of variations with materials in which the propagation speeds are different, as well as variations of the path lengths (FIG. 2), as well as the combination of both methods.

There are also several possibilities for the compensation of rotary phase displacements. One is the geometrical arrangement of the paths (for this, the parts of a path outside the connection line between the beginning and end are to be arranged in such a manner that for each part on one side there is an equally large part on the respective opposite side (FIG. 2)), while another is the calculation compensation by the determination of the rotation by means, for example, of laser gyroscopes and subsequent subtraction.

In all the embodiments the emission is distributed onto the paths and then reassembled for the interferometric evaluation.

An effect is exerted on the design of some embodiments by the lock-in effect (put simply, the fixing of an oscillation node at an imperfection). The lock-in effect in these cases is required for at least two of the three spatial dimensions. If it is not present for one spatial direction (e.g. laser gyroscope), then, in order to acquire a usable measurement signal, the path of greatest difference must have a vector component orthogonally to this spatial direction. The reason for this is that in this case the Sagnac effect does not have any part to play in the movement in this spatial direction free of the lock-in effect, but the displacement of the phase comes about due to the displacement of the emission location, incurred by the speed, in interaction with the different run-time on the individual paths. This result is not unambiguously to be attributed to this spatial direction free of this lock-in effect, because such a phase displacement in this arrangement comes equally about as a result of the Sagnac effect by way of a speed component in the direction of the path of greatest difference (see below). Accordingly, a measure is derived for the speed in this area spanned by the path and the spatial direction free of the lock-in effect. A speed portion which is normal to this area does not issue a signal. If this vectorial speed measure is combined with the measures of vectorial speed measures determined by analog means for further areas which are linearly independent of this area and at the same time linearly independent of one another, then, after simple vector calculation, the measure for the speed in the space is derived. On the other hand, in the case of a lock-in effect which is present for all spatial directions, there is no restriction and the Sagnac effect provides the displacement.

In the event of the lock-in effect being present in these embodiments in all spatial directions, a signal with identical phase angle is fed into both the paths (path 1 has a signal run-time of t₁ and path 2 one of t₂, and let t₁>t₂, e.g. t₁=a*t₂) at the time t₀). If the device does not now move, then an interference signal is present at the measurement location, formed from the signals sent at the times t₀ and t₀+(t₁-t₂). If the device is now moved at a speed v=Δl/Δt, then the displacement caused by this movement is added to both paths, and the respective path, i.e. the respective run-time, accordingly becomes longer (Sagnac effect), specifically for path 2 by At and for path 1 by a* Δt. This means that at the end of the path 1 a phase is present which corresponds to the phase angle of a path of the run-time t₁+a*Δt, and at the end of the path 2, because the original phase was carried by the lock-in effect, a phase is present which corresponds to the phase angle of t₂+Δt. This change in the difference of phase angle in dependence on the speed v by (a−1)*Δt gives a periodic interference signal.

In the event of the lock-in effect not being present in these embodiments for a spatial direction, then, as already described, the path of greatest difference must have a vector component orthogonal to this spatial direction. For this vector component, in a quite similar consideration to that given heretofore, a change is derived in the phase difference by (a−1)*Δt.

The method and/or the device presented here for the measurement of speed vectors detects, for the case of a three-dimensional measurement, all speeds/speed vectors, in total, e.g. starting from the speed of the Milky Way in the universe known to us, via the movement of the Solar System with regard to the galactic centre, via the movement of the Earth in the Solar System, via the inherent movement of the Earth itself, such as the movement of the Earth's crust, through to the inherent or natural movement of the object which is to be measured, like the inherent or natural speed of the device itself. For the determination of the vectorial portion being considered accordingly, the others are therefore to be subtracted.

A further embodiment makes use as a source, for example, in particular a laser, a laser diode (thus a linear gas, liquid, or solid body laser, as well as any kind of ring laser). From the light emission location of this laser, leads e.g. an optical fiber (=LWL) that is split after a short path, and of which one branch (=path) is longer after the split (in the sense of what has been described heretofore) than the other, and which are brought together again for the purpose of interference formation. At the end of this an interference evaluation device (phase comparator) is then arranged, for example with a photodiode as sensor. At that point, the phase angle of the light emitted earlier (stored) is then compared with the phase angle of the light emitted later. The optical fiber is now moved according to the requirement (see above) for the selection of a spatial direction. Alternatively, a physically analogous structure with reflectors and beam dividers is used, as shown in FIG. 2. In particular, the light from the laser used here can be used simultaneously for the measurement of further spatial directions by means of appropriately arranged further split optical fibers.

A further preferred embodiment makes use in principle of the structure of the fiber gyroscope, which has long been known. The fundamental difference here lies in the design of the sensor head (=paths). In this case, this does not consist of a wound optical fiber, but of paths constructed in accordance with the provisions described heretofore. The principle of the structure can be seen from FIGS. 3 and 4. In particular, the light from the laser used in this situation can be used simultaneously for all further split optical fibers arranged accordingly for the measurement of further spatial directions. Instead of the lengthening of one part of the path by folding (FIG. 4), the change in the propagation speed in the medium can also be exploited by the use of a material with different refractive index for the “lengthening” of the path. This naturally also occurs by and in combination of both forms. The principle applies that the greater the difference, the greater the resolution, and the more sensitive the embodiment.

In order to obtain a conception of the scale of the measurement effect, the resultant phase displacement is illustrated on the basis of a typical stepping speed of 3.6 km/hour (3.6 km/hour=1 nm/nsec.). With an assumed distance interval of the light emission locations of one light nanosecond (approx. 30 cm) and a wavelength of the light of 400 nm, this results in a readily mastered measurement value.

The potentially possible repetition rate for measurements is essentially derived from the run-time of the emission on the longer path, as well as the subsequent processing of the signal, and is in the upper MegaHertz range.

Because the method and/or the device presented here represent an inertial working system, a reference to another moved object is represented, for example by simple contact to this. Otherwise the device displays the own speed vector of itself.

In a further preferred embodiment, a path is exploited at least double, in that the emission radiates through it in both (opposed) directions (functional schematic representation in FIG. 3). The advantage of this is the saving of one path for a measuring device in order to minimize the components and reduce thermal and other path conditions.

In a further preferred embodiment, this one path is substituted by two separate paths.

In a further preferred embodiment, for the complete acquisition of a movement-translation and rotation—at least six of the devices represented in accordance with the method described heretofore are distributed in the space in such a way that the measured signals of the measurement axes derived by the method and/or the device can be broken down by a suitably selected mathematical calculation unambiguously into the spatial vectors which characterise a movement, both translatory and rotational speed. The resolution of the rotational speed is improved by the enlargement of the distance intervals of the device and therefore of the measurement axes. One example of the arrangement is the locating of six devices on the six faces of a cube.

In a further preferred embodiment, in which no complete acquisition of a movement is desired and/or required, measurement axes which are not required are left out and/or replaced by other methods and/or devices.

In a further preferred embodiment, the method and/or the device is supplemented by one or more acceleration sensors, such that, without the presence of a movement, a reference can be established to the local gravitational normal.

In a further preferred embodiment, the method and/or the device are supplemented by one or more spirit levels or the like, in such a way that, without a movement being present, a reference can be established to the local gravitational normal.

Areas of application are location and position determination of different objects and subjects or parts thereof, of which only a number are listed here by way of example:

Writing implements, such as pencils, ballpoint pens, computers, computer mouse, bicycles, motorcycles, automobiles, special vehicles such as cranes. mobile bridges, construction vehicles and heavy goods vehicles, railways, Transrapid, helicopters, guided missiles, aircraft, spacecraft, ships, submarines, military vehicles of all kinds, bullets, grenades, rockets, domestic appliances, such as vacuum cleaners, lawnmowers, robots for domestic and industrial use, industrial equipment such as rollers, cranes, forklift trucks, transport pallets, mining and tunneling machinery, such as drills, milling machines, offshore applications such as platform stabilization, deep drilling equipment, toys such as dolls, animals, automobiles, and part components thereof, as well as any object of which it is intended that the degrees of freedom of movement should be determined and/or regulated.

Human beings and human body parts, such as fingers, hands, arms, legs, feet, head and torso. Also internal parts such as the organs or parts thereof.

Animals, and parts thereof (see human beings).

The embodiments described represent only selected examples of a large number of different possible embodiments of the method according to the invention and the device according to the invention.

1. A system, comprising:
at least one source designed for the generation of at least one emission,
at least six devices for the measurement of a speed, which are arranged in the system for the measurement of a speed and of a rotation of the system in different spatial directions, wherein each of the at least six devices (1; 2; 3; 4) exhibits at least two paths, on which, respectively, at least one part of the at least one emission generated by the at least one source propagates with a respective known wavelength and a respective known propagation speed, wherein the paths are formed in such a way that a translatory movement of the individual device causes a phase displacement between the emission parts propagated on the at least two paths of the device, and
evaluation means designed for the detection of emission parts which leave the respective at least two paths of the devices, and for the determination of the speed of each of the devices in at least one spatial direction, respectively, by the evaluation of a change in the phase displacement between the detected emission parts in comparison with a phase displacement with the device at rest,
wherein the system is designed in such a way that a change in the phase displacement of the emission parts detected by the evaluation means for respectively one of the devices due to a rotational movement of this device is prevented or compensated for.

2. The system according to claim 1, wherein the at least two paths of a respective device exhibit different materials or different combinations of materials.

3. The system according to claim 2, wherein the at least two paths (21, 22) of a respective device (2) exhibit different geometric lengths.

4. The system according to claim 3 wherein, in order to prevent a change in the phase displacement between the emission parts detected by the evaluation means due to a rotational movement of a respective device, each of the at least two paths of the device exhibits, outside an imaginary straight line, path parts of essentially equal size on opposite sides of this straight line.

5. The system according to claim 3, further comprising detection means designed for the detection of a rotational movement of a respective device, wherein the evaluation means are designed for the compensation of a change incurred by a rotational movement on the at least two paths of the respective device in the phase displacement between detected emission parts on the basis of information from the detection means.

6. The system according to claim 5, wherein the at least two paths of the respective device are designed in such a way that they exhibit at least one common path section, which is run through in opposite directions by the emission parts fed into the at least two paths.

7. The system according to claim 6, wherein the common path section is designed in such a way that it exhibits a path part which is run through by one of the emission parts essentially in the direction of measurement of the respective device and a path part which is run through by this emission part essentially in the opposite direction, wherein the two path parts, with the device at rest, exhibit a different physical length.

8. The system according to claim 7, further comprising an acceleration sensor designed for creating a reference to the local gravity normal.

9. The system according to claim 8, wherein the at least six devices are arranged on the six faces of a cube, wherein the devices exhibit on adjacent faces measurement axes aligned at right angles to one another, and wherein the devices exhibit on mutually opposing faces measurement axes aligned opposite to one another.

10. A method for the measurement of a speed and a rotation of a system, wherein the method comprises for each of six devices of the system, arranged in different spatial directions:
the generation of at least one emission,
the transfer of respectively at least one part of the at least one emission on at least two paths with a respective known wavelength and a respective known propagation speed, wherein a translatory movement of the device causes a phase displacement between the emission parts propagating on the at least two paths,
the detection of the emission parts leaving the at least two paths and
the determination of the speed of the device in at least one spatial direction by the evaluation of a change in the phase displacement between the detected emission parts in comparison with a phase displacement with the device at rest, wherein a change in the phase displacement of the emission parts due to a rotational movement of the device is prevented or compensated for,
wherein the method further comprises a determination of the speed and the rotation of the system from the speeds detected for the respective device.

11. The method according to claim 10, wherein the at least six devices are arranged on the six faces of a cube, wherein the devices on adjacent faces determine the speed in spatial directions at right angles to one another, and wherein the devices on opposite faces determine the speed in spatial directions opposed to one another.

12. The system according to claim 1, wherein the at least two paths of a respective device exhibit different geometric lengths.

13. The system according to claim 1, wherein, in order to prevent a change in the phase displacement between the emission parts detected by the evaluation means due to a rotational movement of a respective device, each of the at least two paths of the device exhibits, outside an imaginary straight line, path parts of essentially equal size on opposite sides of this straight line.

14. The system according to claim 1, further comprising detection means designed for the detection of a rotational movement of a respective device, wherein the evaluation means are designed for the compensation of a change incurred by a rotational movement on the at least two paths of the respective device in the phase displacement between detected emission parts on the basis of information from the detection means.

15. The system according to claim 1, wherein the at least two paths of the respective device are designed in such a way that they exhibit at least one common path section, which is run through in opposite directions by the emission parts fed into the at least two paths.

16. The system according to claim 15, wherein the common path section is designed in such a way that it exhibits a path part which is run through by one of the emission parts essentially in the direction of measurement of the respective device and a path part which is run through by this emission part essentially in the opposite direction, wherein the two path parts, with the device at rest, exhibit a different physical length.

17. The system according to claim 1, further comprising an acceleration sensor designed for creating a reference to the local gravity normal.

18. The system according to claim 1, wherein the at least six devices are arranged on the six faces of a cube, wherein the devices exhibit on adjacent faces measurement axes aligned at right angles to one another, and wherein the devices exhibit on mutually opposing faces measurement axes aligned opposite to one another.
